(19) United States
(12) Patent Application Publication
(10) Pub. No.: US 2006/0248792 A1
(43) Pub. Date: Nov. 9, 2006

(54) Integrated surf wax comb and applicator

(76) Inventor: Christopher D. Huxley, Solana Beach, CA (US)

Correspondence Address: John A. Mizhir, Jr.;Mizhir & Associates, Suite 201, 2356 Moore Street, San Diego, CA, 92110, US

(21) Appl. No.: 11/364,614

(22) Filed: Feb. 28, 2006

Related U.S. Application Data
(60) Provisional application No. 60/657,214, filed on Feb. 28, 2005.

(51) Int. Cl. A01M 21/04

(52) U.S. Cl. 47/1.5

(57) ABSTRACT

An apparatus for applying and distributing a solid, pliable material to a surface comprising an applicator housing unit having at least one open end and an integrated wax comb applicator cap releaseably attached to the at least one open end of the applicator housing unit. The integrated comb has at least one portion adapted for manipulating and distributing the material on the surface, while the housing unit can have a mechanism to advance and retract the material. The housing unit and the cap can also be connected by a string, leash, or other similar device. In another embodiment of the apparatus, the wax comb is integrated into the applicator housing, while in another embodiment one portion of the comb is integrated into applicator housing, while the other portion of the comb is integrated into the applicator cap. In still another embodiment, the comb is integrated on a cylinder that is coaxially and slidably positioned around the housing and can be advanced and retracted as needed.

### CROSS-REFERENCE TO RELATED APPLICATIONS

The present application claims priority to U.S. Provisional Patent Application Ser. No. 60/657,214 entitled INTEGRATED WAX COMB AND APPLICATOR, by Christopher D. Huxley, filed Feb. 28, 2005, the entirety of which is hereby specifically incorporated by reference for all it discloses and teaches.

### FIELD OF INVENTION

The invention relates to an apparatus for storing, applying and then combing and distributing a substance, such as wax, on a surface.

### STATEMENT AS TO RIGHT TO INVENTIONS MADE UNDER FEDERAL SPONSORED RESEARCH AND DEVELOPMENT

None

### BACKGROUND OF THE INVENTION

Most people do not realize that in addition to a surfboard and waves, surf wax is an important ingredient of the sport of surfing. Surf wax is applied to a surfboard for two main reasons. First, it prevents the surfer from slipping off the surfboard when paddling or while standing on it. And second, it allows the surfer to grasp the board for duck diving through the waves or popping-up onto the board. For these reasons, a market exists for devices that facilitate the housing, application, combing and distribution of surf wax.

In its most common form, surf wax is shaped in hand-sized blocks or discs and is packaged in a protective cellophane material that is initially effective, but which subsequently has its drawbacks. For one, once the cellophane wrapper is removed, the wax becomes difficult to store and as a result, can easily become exposed to the elements (e.g. sand, lint, dirt, heat, and the like.) and is compromised in quality. Moreover, the loose, unprotected wax can damage carpet, clothing, beach bags, coolers, car interiors, towels, and anything else in touches, especially if as is often the case, it melts. Still further, surf wax is often unnecessarily wasted. In particular, surf wax is typically applied using the wax itself as a handle. For this reason, a portion of the wax, which is otherwise still useable, is discarded because the surfer is left with nothing to hold on to when applying it.

Once the surf wax has been applied, a surf comb is generally used to smooth and distribute the wax evenly at the desired spots on the surface of the board. Frequently, however, surfers misplace or lose the comb, making the process of waxing a board difficult if not impossible. In fact, a surfer can end up replacing several combs over a season, which gets costly.

Attempting to overcome these shortcomings, surf wax applicator and comb assemblies have been designed and marketed. For instance, U.S. Pat. No. 5,219,238 to Hainbach is directed to a container for holding a disc of surf wax. The container also has an opening to receive and store a surf comb. Similarly, U.S. Pat. No. 6,821,041 to Hallam et. al discloses a symmetrical wax storage applicator with a pusher member for advancing the wax. A blade portion, including a scraper edge and a comb edge, is connected to the applicator cap by way of an intermediary blade support.

### SUMMARY OF INVENTION

The disclosed apparatus provides a convenient, efficient and simple alternative for storing, applying, combing and distributing a substance, such as surf wax, on a surface, such as a surfboard. One embodiment of the disclosed apparatus has an applicator housing and a surf comb integrated into the applicator cap. The housing holds replaceable or irreplaceable wax cartridges that can be advanced or retracted. And because the comb is integrated into the cap, the surfer has all of the necessary tools in one package, significantly reducing the likelihood that either the comb or the applicator will be lost or misplaced, and it further obviates the problems associated with loose and exposed wax. Also, by integrating the comb into the cap rather than just connecting it by some mechanism or providing an opening to hold it, the comb cannot be broken away from the cap. Another embodiment of the apparatus integrates the surf comb into the applicator housing, rather than into the cap, but still provides the same advantages. Another embodiment provides for one portion of the comb, e.g., the teeth, to be integrated into the applicator housing, while the other portion of the comb, e.g., the blade, is integrated into the applicator cap. In a still further embodiment of the apparatus, the comb is integrated on a cylinder that is coaxially and slidably positioned around the housing and can be advanced and retracted as needed.

### BRIEF DESCRIPTION OF DRAWINGS

FIGS. 1 and 1(a) illustrate a first implementation of the apparatus;

FIG. 2 illustrates a second implementation of the apparatus;

FIG. 3 illustrates a fourth implementation of the apparatus;

FIG. 4 illustrates a fifth implementation of the apparatus;

FIG. 5 illustrates a sixth implementation of the apparatus; and

FIGS. 6(a)-(c) illustrate different views of a seventh implementation of the apparatus.

### DESCRIPTION OF PREFERRED EMBODIMENTS

While the disclosed apparatus is susceptible of numerous implementations, there is shown in the drawings and herein described in further detail, exemplary implementations, with the understanding that the present disclosure is to be considered as illustrative of the principles of the apparatus and not intended to limit the invention to the exemplary embodiments shown and described.

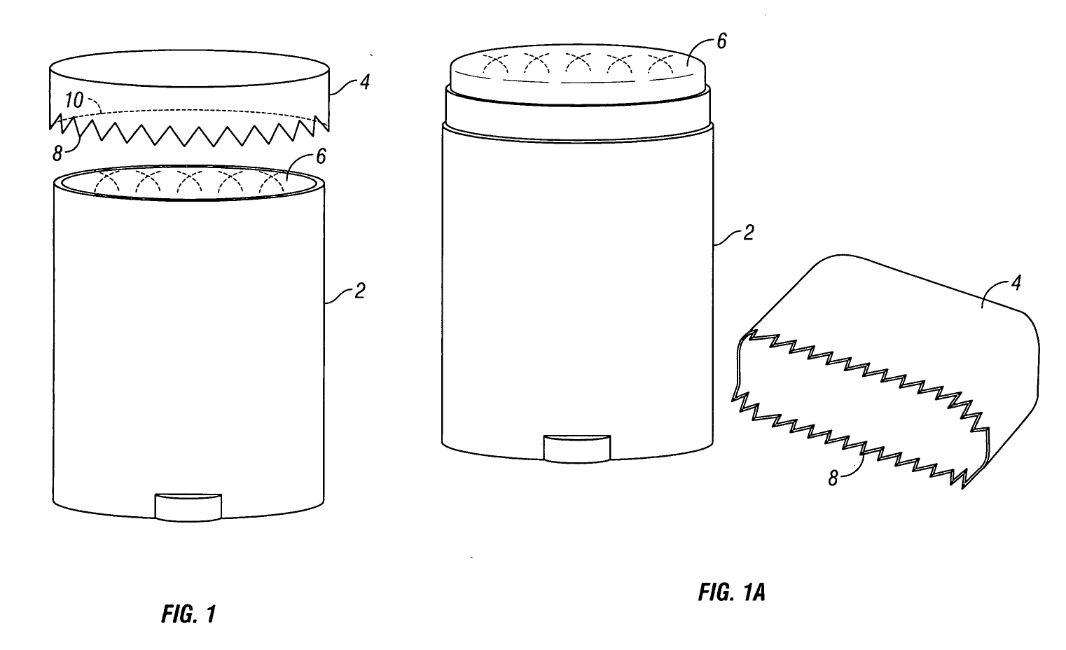

FIGS. 1 and 1(a) illustrate a first implementation of the apparatus comprising an applicator housing 2 with a cap 4. The housing 2 can hold irreplaceable or replaceable cartridges or portions of a substance, such as wax 6, and is designed to allow a user to advance and retract the wax 6 as necessary. For instance, the applicator 2 can be designed like a common retractable applicator like those used with deodorant, lip balm and other similar products. Of course, other known or obvious means for advancing and retracting the wax can also be employed. Because of its design, the applicator 2 permits a user to apply wax 6 to any surface, including surfboards, paddle boards, snowboards, or skis, and to retract the wax 6 within the housing 2 when not in use.

As seen in FIG. 1, the cap 4 can be designed as a surf comb. For instance, a first bottom edge 8 of the cap 4 can be designed as or to have attached to it teeth, serrations, or other similar devices for distributing the wax 6 after it is applied to the surface. A second opposite bottom edge 10 of the cap 4 can be designed as or to have attached to it a blade, which can be flat, concave, convex, or any other shape that can scrape off excess or smooth the applied wax. The cap 4 may be entirely or partially detachable from the applicator housing 2. For instance, the cap 4 may be indirectly attached to the housing 2 by a string or leash 12 (not shown) to ensure the cap 4 is not misplaced.

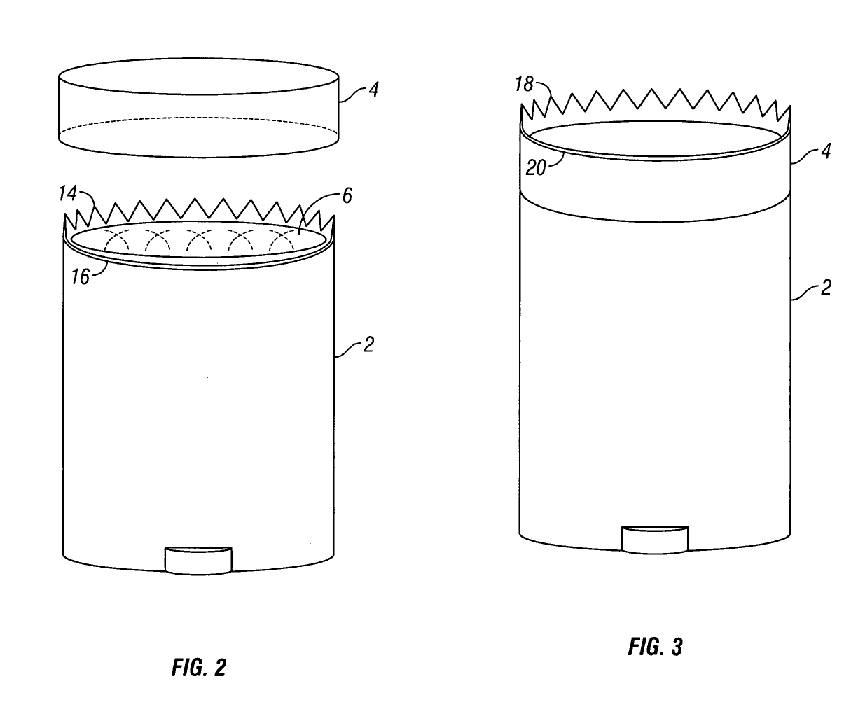

FIG. 2 illustrates a second implementation of the apparatus, wherein the top portion of the applicator housing 2 is formed as a wax comb. In particular, a first top edge 14 of the housing 2 can be designed as or to have attached to it teeth, serrations or other similar devices, while a second opposite top edge 16 of the housing 2 can be designed as or to have attached to it a blade. In this second implementation, the user applies the wax, then retracts the wax to a point below the first and second edges 14 and 16, respectively, before scratching, distributing or smoothing the applied wax.

Various implementations interchanging the aspects of the first and second implementations are also contemplated. For instance, a third implementation of the apparatus may employ the cap 4 of the first implementation and the housing applicator 4 of the second implementation. In this third implementation, the first bottom edge 8 of the cap 4 that has teeth would correspond to the teeth on the first top edge 14 of the applicator 2, while the second bottom edge 10 of the cap 4 would meet or overlap the second top edge 16 of the applicator 2. Of course, other similar variations can also be employed.

A fourth implementation of the apparatus is illustrated in FIG. 3. In this implementation, a first top edge 18 of the cap 4 can be designed as or to have attached to it teeth, serrations, or other similar devices, while, a second opposite top edge 20 of the cap 4 can be designed as or to have attached to it a blade. Again, the cap 4 may be entirely or partially detachable from the applicator housing 2.

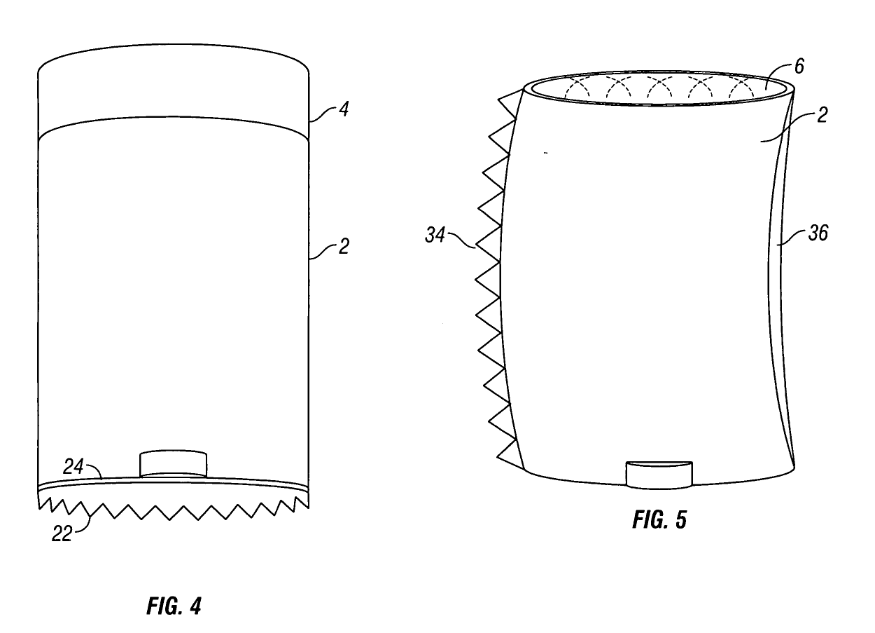

In yet another fifth implementation of apparatus, as seen in FIG. 4, the bottom of the applicator housing 2 may be formed as a wax comb. For example, a first bottom edge 22 of the housing 2 can be designed as or to have attached to it teeth, serrations or other similar devices, while a second opposite bottom edge 24 of the housing 2 can be designed as or have attached to it a blade.

Moreover, as is illustrated in FIG. 5, which depicts a sixth implementation of the apparatus, instead of the wax comb being formed on either the top 14 and 16 or bottom 22 and 24 edges of the applicator 2 or cap 4, the sides of the applicator 2 or flanges along the sides of the applicator 2 can be formed as the wax comb. For example, at least one side portion 34 of the applicator 2 (or longitudinal flange [not shown] along the applicator 2) can be designed as or to have teeth, serrations or other similar devices, while at least another side portion 36 of the applicator 2 (or longitudinal flange) can be designed as or to have a blade.

It is contemplated that any of the above-described implementations may be interchanged and employed as alternative variations of the apparatus. For instance, one or more of the top 18 or 20 or bottom 8 and 10 edges of the cap 4 and one or more of the top 14 and 16 and bottom 22 and 24 edges of the applicator 2 may have teeth or a blade. Moreover, at least one side portion 34 and 36 of the applicator 2 can be designed as or have teeth, serrations or other similar devices, while one or more of the top 18 or 20 or bottom 8 and 10 edges of the cap 4 and one or more of the top 14 and 16 and bottom 22 and 24 edges of the applicator 2 can be designed as or have a blade.

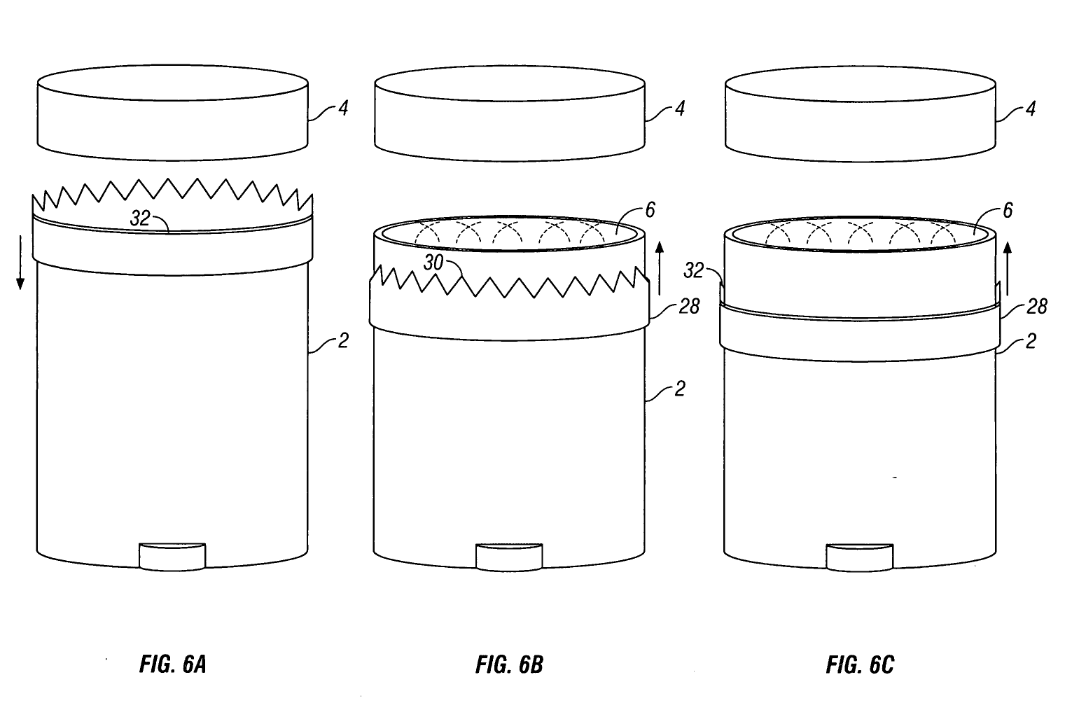

FIGS. 6(a)-(c) illustrate yet another implementation of the apparatus. In contrast to the previous implementations, the teeth and blade portions of the wax comb are on a first 30 and second 32 edge of a cylinder 28 that is coaxially and slidably positioned around the applicator housing 2. To facilitate the sliding movement of the cylinder 28, various mechanisms including a corresponding tongue and groove configuration on the applicator 2 and cylinder 28 can be employed. The cylinder 28 may be positioned at the top or bottom portions of the applicator 2. If at the top, as seen in FIGS. 6(a)-(c), the wax 6 is applied and the cylinder 28 is advanced upwardly, as is shown by the arrow in FIGS. 6(b), and (c) beyond the top of the wax 6, as seen in FIG. 6(a), to allow the first 30 and second 32 edges of the cylinder 28 to engage the waxed surface, and then retracted downwardly, as shown by the arrow in FIG. 6(a), to return the cylinder 28. Alternatively, if the cylinder 28 is positioned at the bottom of the applicator 2 (in a position upside down to the one depicted), the wax 6 is applied, the applicator 2 is turned upside down, and the cylinder 28 is advanced forward beyond the bottom of the applicator 2 to engage the waxed surface. Regardless of the position of the cylinder 28 (top or bottom portions of the applicator 2) it may be have a lock mechanism (not shown) to ensure it does not move while in use or not in use.

Again, any of the above-described implementations may be interchanged and employed as alternative variations of the apparatus.

1. An apparatus for storing, applying and distributing a solid, pliable material to a surface comprising the following:
an applicator housing unit having at least one open end; and
an integrated wax comb applicator cap releaseably attached to the at least one open end of the applicator housing unit.

2. The apparatus of claim 1, wherein the applicator housing unit further comprises a mechanism for moving the solid.

3. The apparatus of claim 1, wherein the integrated comb has at least one portion adapted for manipulating and distributing a solid material on a surface.

4. The apparatus of claim 1, wherein the integrated comb has teeth.

5. The apparatus of claim 1, wherein the integrated comb has a blade.

6. The apparatus of claim 1, wherein a portion of the integrated comb has teeth and a portion has a blade.

7. The apparatus of claim 1, wherein the applicator housing unit has integrated a wax comb having at least one portion adapted for manipulating and distributing a solid material on a surface.

8. The apparatus of claim 1, wherein a device connects the applicator housing and the applicator cap.

9. An apparatus for storing, applying and distributing a solid, pliable material to a surface comprising the following:
an integrated wax comb applicator housing unit having at least one open end; and
an applicator cap releaseably attached to the at least one open end of the applicator housing unit.

10. The apparatus of claim 9, wherein the applicator housing unit further comprises a mechanism for moving the solid.

11. The apparatus of claim 9, wherein the integrated comb has at least one portion adapted for manipulating and distributing a solid material on a surface.

12. The apparatus of claim 9, wherein a portion of the integrated comb has teeth and a portion has a blade.

13. The apparatus of claim 9, wherein a device connects the applicator housing and the applicator cap.

14. An apparatus for storing, applying and distributing a solid, pliable material to a surface comprising the following:
an applicator housing unit having at least one open end;
an applicator cap releaseably attached to the at least one open end of the applicator housing unit; and
an integrated surf comb cylinder coaxially and slidably positioned around the applicator housing unit.

15. The apparatus of claim 14, wherein the applicator housing unit further comprises a mechanism for moving the solid.

16. The apparatus of claim 14, wherein the integrated surf comb cylinder has at least one portion adapted for manipulating and distributing a solid material on a surface.

17. The apparatus of claim 14, wherein the integrated comb has teeth.

18. The apparatus of claim 14, wherein the integrated comb has a blade.

19. The apparatus of claim 14, wherein a portion of the integrated comb has teeth and a portion has a blade.

20. The apparatus of claim 14, wherein the cylinder can be locked into place by a lock mechanism.
